(19) United States
(12) Patent Application Publication
(10) Pub. No.: US 2014/0297406 A1
(43) Pub. Date: Oct. 2, 2014

(54) MOBILE DEVICE APPLICATION, SYSTEM AND METHOD FOR MARKETING TO CONSUMERS DURING A BUYING DECISION

(71) Applicants: Dan Manning, Phoenix, AZ (US); Tim Manning, New Fairfield, CT (US)

(72) Inventors: Dan Manning, Phoenix, AZ (US); Tim Manning, New Fairfield, CT (US)

(21) Appl. No.: 13/851,214

(22) Filed: Mar. 27, 2013

(51) Int. Cl. G06Q 30/02

(52) U.S. Cl. CPC G06Q 30/0267; G06Q 30/0255
USPC 705/14.53

(57) ABSTRACT

A system, method and apparatus is disclosed for pushing coupons and marketing materials via mobile device application to consumers during buying decisions (as they shop), during the purchasing decision (marketing at the point decision); at or immediately before checkout of a retail outlet (confirming price accuracy and efficiently checking out the consumer The mobile device application can also collect purchasing information for future marketing and coupon offers related to the consumer's purchasing selections.

### CROSS REFERENCE TO RELATED APPLICATIONS

The present application relates to and takes priority from co-pending U.S. provisional application Ser. No. 61/617,292, filed on Mar. 29, 2012 and entitled “A MOBILE DEVICE APPLICATION, SYSTEM AND METHOD FOR MARKETING TO CONSUMERS DURING A BUYING DECISION”, which application is hereby incorporated by reference in its entirety.

### BACKGROUND OF THE INVENTION

The present invention relates generally to an apparatus, system and method for marketing to consumers during or immediately preceding a consumer's purchasing decision using a mobile device application. More specifically, the mobile device application will provide real time purchase price information as well as coupon information for similar items being considered by the consumer at or near the point of purchasing.

The current state of the market includes various applications for mobile devices where a consumer may receive updated coupon information for certain retail products. Sellers and/or providers of consumer goods and services, and advertisers and providers of marketing devices, herein also referred collectively as “product marketers” are constantly looking for new ways to provide advertising and/or marketing devices to potential customers more effectively and efficiently. This includes new ways to more specifically target a given “type” of consumer having a given consumer spending profile. Consequently, many product marketers would benefit from: identifying if, and when, a given consumer is interested in particular product during the purchasing decision. If product marketers had this information, then a product marketer could target a given consumer with one or more marketing devices such as, but not limited to: coupons, advertisements, discount certificates, price guarantees, and vouchers.

In addition, most consumers would prefer to receive advertising via their mobile phone that is relevant to the consumer immediately before the purchase of that product so the consumer has the most up to date pricing information.

Despite the desire of product marketers, as well as consumers, to create a better system for reaching desirable consumers, there currently is often no information, or limited information, available to the product marketers about a given consumer to enable the product marketers to accurately profile a given consumer with respect supplementary income.

As a result of the situation discussed above, product marketers are denied the opportunity to identify and target particularly desirable consumers based on their supplementary income usage, and consumers are also denied savings and efficiency that might otherwise be available to them. Consequently, the current situation represents a disservice to product marketers, as well as consumers.

There is thus a need for a mobile application for selectively pushing coupons to consumers during buying decisions (marketing at the point decision), at checkout (confirming price accuracy and efficiently pay, and identifying personality future marketing information (user choice selections).

Such a system will also efficiently maximize check processing via the mobile telephone with up to date price information, coupon information, loyalty award information and billing information for the consumer such that the user may be checked out in a register line designed for the instant mobile phone application check out system.

### SUMMARY OF THE INVENTION

The present invention includes a system, method for apparatus for pushing coupons, marketing and a mobile check out system to consumers during buying decisions (marketing at the purchasing point decision) at or before checkout (confirming price accuracy and efficiently check out). In addition that; and personal purchase information can be collected for future marketing efforts tailored to the consumer based upon the consumer's purchasing selections.

At the point of purchase cross marketing of coupons can be forwarded to the consumer during the purchasing decision without the need to clip coupons. An advantage of the present invention is that consumers can assemble an order, apply a payment and coupons, and check out and as they shop. This will greatly enhance a shopping experience by accelerating the checkout process and removing lines to check out. In addition, sellers may automatically apply any available store coupons in real time as the consumer shops to the order, ensuring the consumer has the most up to date pricing and coupons while in the store.

Furthermore, manufacturer's coupons also can be offered as the consumer makes purchasing decisions. For example: a consumer may scan a case of Coca Cola soda and the system will show in real time an updated price, coupon and perhaps a competitor's price and coupon. This advantage of the present invention is of critical importance as never before have manufacturers been able to advertise this effectively, at the time of purchase.

A further advantage of the present invention is the improvement to grocery store cash flow by speeding up manufacturer coupon payment process. Additionally, the present invention can advantageously provide marketing directly to the consumer based on a location in store, provide details of consumers purchasing decisions and habits, and track the consumer's path within the store.

In some embodiments the invention advantageously provides a product list tailored for a consumer's buying decisions, providing a map of item locations proximate relative to the consumer's location, a list of up to date prices and a mechanism for automated check out without the need to scan and check in each product.

Preferred embodiments include geo locating technology, RFID scanning, UPC scanning, photo identification, wi-fi network location, cell phone network location and other similar location based identification systems applicable to allow the system to identify local coupons for the consumer.

In a first aspect the present intention is embodied in software application for implementation on a mobile device, the mobile device including a database and a GUI, the database comprising software code instructions for performing the steps of determining a first location of a user; based upon the location, identifying preferred product purchases of the user; displaying coupons and marketing materials to the user via the GUI; tracking the user's product selection on a real time basis; confirming real time price information regarding the selected products; and based upon the selected and tracked products, checking out the user's product selections at a point of sale location within the first location.

In some embodiments the application includes implementing a GPS software application and implementing an RFD software application.

In some embodiment the application includes collecting purchasing information about the user for future purchasing decision analysis. The application according may also include step includes searching at least one database having real time price information regarding the selected products.

In some embodiment a consumer's loyalty program information can be updated in real time providing additional coupons related to the particular store's loyalty program credits.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 is a block diagram showing an exemplary computing environment in which aspects of the present invention may be implemented; and

FIG. 2 is a flow diagram of an exemplary flow diagram according to one embodiment of the present invention.

FIG. 3 is a flow diagram of another exemplary flow diagram according to one embodiment of the present invention.

### DETAILED DESCRIPTION OF THE PREFERRED EMBODIMENTS

The present disclosure will now be described more fully with reference to the Figures in which embodiments of the present disclosure are shown. The subject matter of this disclosure may, however, be embodied in many different forms and should not be construed as being limited to the embodiments set forth herein.

Exemplary Operating Environment

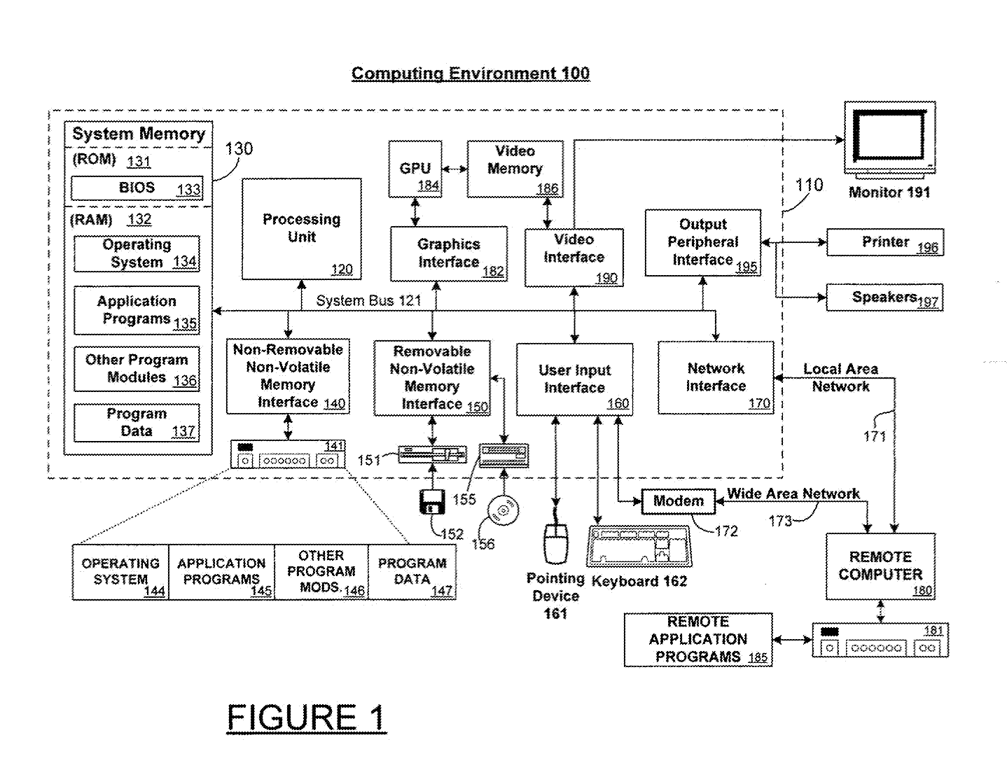

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The invention is preferably implemented via a mobile telephone device. However any mobile electronic device having a GUI, a database, or access thereto, and a network connection, or access thereto, can be used to implement the present invention.

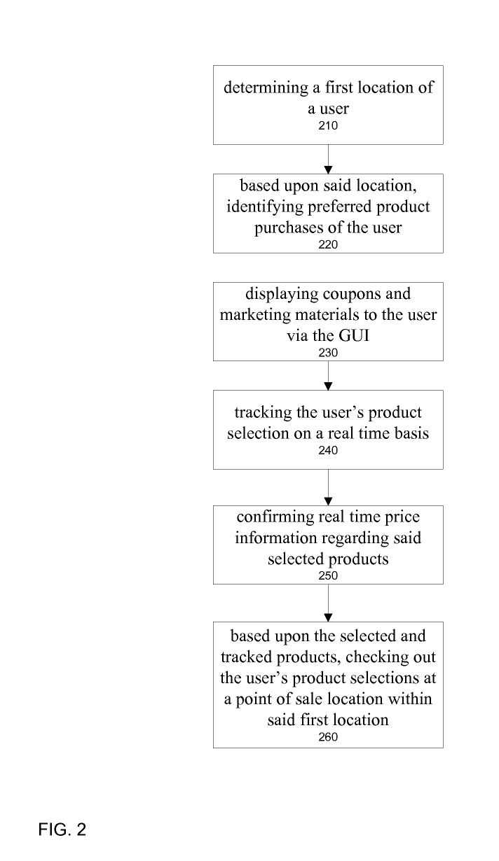

FIG. 2 shows a flow diagram of an exemplary software process according to one embodiment of the invention. Accordingly, the invention includes a software application for implementation on a mobile device, where the mobile device includes access to a database and a GUI, the database comprising software code instructions. Shown in box 210 there is step of determining a first location of a user. The user can be located in any retail outlet store, such a grocery food store, clothing store any retail sales outlet.

In box 220, based upon the determined location, the software code instructions include identifying preferred product purchases of the user at that location as well as other comparative purchases of products similar to those sold at the location. Next, displaying coupons and marketing materials to the user via the GUI occurs as shown in box 230. The marketing materials can be for products sold within the location or alternatively at other competing locations.

In box 240 the system implements a tracking step the user's purchase by tracking the user's product selection on a real time basis. The system then implements a step of confirming real time price information regarding said selected products as shown in box 250. The real time information can be determined from the location inventory and price information databases. Alternatively, the real time information can be ascertained from off site databases housing such information on real time basis across multiple distant locations.

Based upon the selected and tracked products, as shown in box 260, the system implements a step for checking out the user's product selections at a point of sale location within the first location. This location is likely the checkout line where registers can be located with RFID technology, GPS, Bluetooth or other wireless techno logy that automatically clears all of the user's products quickly and efficiently so the user can limit any time on a checkout line. The invention also includes collecting purchasing information about the user for future purchasing decision analysis as well as continually searching at least one database having real time price information regarding said selected products.

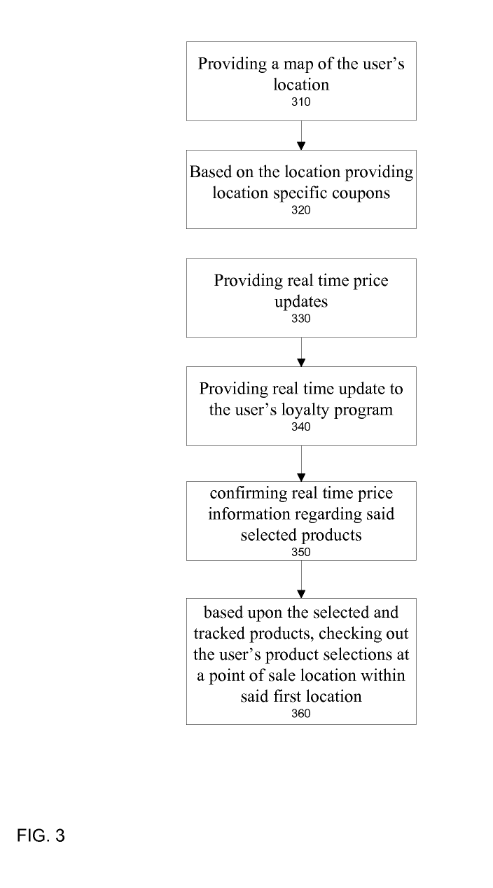

Referring now to FIG. 3, the system provides a store map of the location of the user (box 310). Preferably, the mobile device includes software programmed to push coupons, marketing and a mobile check out system to consumers during buying decisions (marketing at the purchasing point decision) (box 320) at or before checkout (confirming price accuracy and efficiently check out) (box 330). In addition, personal purchase information can be collected for future marketing efforts tailored to the consumer based upon the consumer's purchasing selections, such as loyalty programs (box 340).

At the point of purchase cross marketing of coupons can be forwarded to the consumer during the purchasing decision without the need to clip coupons (box 350).

A product list tailored for a consumer's buying decisions can be generated from information saved about the purchaser's buying habits and past purchases (box 360). When the consumer enters into a previously entered store, the system can upload providing a map of item locations proximate relative to the consumer's location, a list of up to date prices and a mechanism for automated check-out without the need to scan and check in each product.

Preferred mobile devices will include geo locating technology, RFID scanning, UPC scanning, photo identification, wi-fi network location, cell phone network location and other similar location based identification systems applicable to allow the system to identify local coupons for the consumer.

It will be apparent to one of skill in the art that described herein is a novel system and mobile device application for marketing to consumers during a buying decision. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims.

1. A software application for implementation on a mobile device, the mobile device including a database and a GUI, the database comprising software code instructions for performing the steps of:
determining a first location of a user;
based upon said location, identifying preferred product purchases of the user;
displaying coupons and marketing materials to the user via the GUI;
tracking the user's product selection on a real time basis;
confirming real time price information regarding said selected products; and
based upon the selected and tracked products, checking out the user's product selections at a point of sale location within said first location.

2. The application according to claim 1 where said determining step includes implementing GPS software application.

3. The application according to claim 1, where said tracking step includes implementing an RFD software application.

4. The application according to claim 1, further comprising collecting purchasing information about said user for future purchasing decision analysis.

5. The application according to claim 1, where said confirming step includes searching at least one database having real time price information regarding said selected products.
